(19) United States
(12) Patent Application Publication
(10) Pub. No.: US 2024/0403964 A1
(43) Pub. Date: Dec. 5, 2024

(54) HYBRID CELL MANAGEMENT SERVICE

(71) Applicant: Authentic Insurance Services, Inc., New York, NY (US)

(72) Inventors: Cole K. Riccardi, New York, NY (US); Saravanakumar Shanmugam Sakthivadivel, New York, NY (US); Kyle Babirad, Dayton, OH (US); Ezekiel B. Scherl, New York, NY (US); Madina Bolat, Dayton, OH (US); William Mandelbaum, New York, NY (US); Jacob Eli Haas Frank, Brooklyn, NY (US); Logan John Ross, Brooklyn, NY (US)

(73) Assignee: Authentic Insurance Services, Inc., New York, NY (US)

(21) Appl. No.: 18/326,618

(22) Filed: May 31, 2023

(51) Int. Cl. G06Q 40/08

(52) U.S. Cl. CPC G06Q 40/08

(57) ABSTRACT

A hybrid real-world and virtual cell service provides requesting tenants with hybrid cells that include a real-world entity acquired by the hybrid real-world and virtual cell service and a virtual entity configured to provide virtualized services for managing the real-world entity. The hybrid real-world and virtual cell service maintains a plurality of types of real-world entities as well as templates comprising workflows, machine images, and/or software containers for automatically implementing virtualized services for managing the real-world entities. Tenants of the hybrid real-world and virtual cell service may be allocated a hybrid cell comprising a real-world entity and an associated virtual entity. The tenant may use the real-world entity to provide services to customers of the tenant and may rely on the provided virtual entity to manage customer interactions, on behalf of the tenant, without tenant interactions being required for managing the customer interactions.

### BACKGROUND

Increasingly, cloud-based service providers are offering users tools for managing various types of activities, such as performing tasks using software and hardware provided by the cloud-based service providers. Such tasks that are performed “in the cloud” may be performed by virtual entities such as virtualized software abstractions implemented on shared computing infrastructure in the cloud, and may be referred to as “virtualized services.” However, for various reasons, other tasks may not be suitable to be performed by virtual entities. For example, some activities and tasks may require real-world entities. As an example, certain activities involving approvals from governmental bodies may require real-world entities.

However, lead times for creation of real-world entities and lead times for implementation of virtualized services may vary widely. For example, virtualized services may be provided by a cloud-based service provider nearly immediately in response to a change in demand. In contrast, creating a real-world entity may take a year or more to complete, including time for government approvals.

### BRIEF DESCRIPTION OF THE DRAWINGS

FIG. 1 is a logical block diagram illustrating a hybrid real-world and virtual cell service along with real-world entities and cloud-based computing resources that are used in hybrid cells provided by the hybrid real-world and virtual cell service, according to some embodiments.

FIG. 2 is a logical block diagram illustrating an example implementation of a hybrid real-world and virtual cell service that provides hybrid cells that include real-world sponsored captive insurance pool cells, according to some embodiments.

FIG. 3 is a logical block diagram illustrating templates used by a hybrid real-world and virtual cell service to provide virtual services that are matched to a type of real-world entity being provided in the hybrid real-world and virtual cell, according to some embodiments.

FIG. 4 is a logical block diagram illustrating additional details regarding a hybrid cell inventory management system included in the hybrid real-world and virtual cell service, according to some embodiments.

FIG. 5 is a logical block diagram illustrating additional details regarding a hybrid cell service manager included in the hybrid real-world and virtual cell service, according to some embodiments.

FIG. 6 is a logical block diagram illustrating additional details regarding a tenant interface included in the hybrid real-world and virtual cell service, according to some embodiments.

FIG. 7 illustrates an example webpage of a tenant of the hybrid real-world and virtual cell service, wherein the hybrid real-world and virtual cell service has provided the tenant with program instructions for incorporating hybrid-real world and virtual cell service provided content into the tenant's webpage, such that the content appears with tenant content, according to some embodiments.

FIG. 8 illustrates an example webpage of a tenant of the hybrid real-world and virtual cell service, wherein the hybrid real-world and virtual cell service has provided the tenant with program instructions for incorporating content into the tenant's webpage that implements a redirection workflow that redirects customers of the tenant to content provided by the hybrid real-world and virtual cell service, according to some embodiments.

FIG. 9 illustrates an example webpage of a tenant of the hybrid real-world and virtual cell service, wherein the hybrid real-world and virtual cell service has provided the tenant with program instructions for incorporating content into the tenant's webpage that implements an application programmatic interface (API) integration that forwards requests provided by customers of the tenant to APIs of the hybrid real-world and virtual cell service and returns responses to the requests back to the customers via the tenant's webpage, according to some embodiments.

FIG. 10 illustrates an example process executed by a hybrid real-world and virtual cell service to add additional real-world entity capacity via creation of an additional captive insurance pool, according to some embodiments.

FIG. 11 is a flow diagram illustrating a process executed by a hybrid real-world and virtual cell service to provide one click acceptance products to customers of tenants of the hybrid real-world and virtual cell service, according to some embodiments.

FIG. 12 is a flow diagram illustrating a process executed by a hybrid real-world and virtual cell service to provide a hybrid cell to a requesting tenant of the hybrid real-world and virtual cell service, according to some embodiments.

FIG. 13 is a flow diagram illustrating a process executed by a hybrid real-world and virtual cell service to provide a requesting tenant a recommendation regarding a type of hybrid cell to use to provide real-world and virtual services to customers of the tenant, according to some embodiments.

FIG. 14 is a flow diagram illustrating a process executed by a hybrid real-world and virtual cell service to provide virtualized services to customers of a tenant, according to some embodiments.

FIG. 15 illustrates an example architecture of a hybrid real-world and virtual cell service, according to some embodiments.

FIG. 16 is a block diagram illustrating an example computing device that may be used to implement various aspects of the services and systems described herein, according to some embodiments.

While embodiments are described herein by way of example for several embodiments and illustrative drawings, those skilled in the art will recognize that the embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). The words “include,” “including,” and “includes” indicate open-ended relationships and therefore mean including, without limitation to. Similarly, the words “have,” “having,” and “has” also indicate open-ended relationships, and thus mean having, but not limited to. The terms “first,” “second,” “third,” and so forth as used herein are used as labels for nouns that they precede, and do not imply any type of ordering (e.g., spatial, temporal, logical, etc.) unless such an ordering is otherwise explicitly indicated.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

### DETAILED DESCRIPTION

Various embodiments of systems and methods for implementing, allocating, and servicing hybrid cells are disclosed. A hybrid cell involves both a real-world entity portion and a virtual entity portion. For example, a business entity may be represented by the real-world entity portion and virtualized services that support the business entity may be represented by the virtual entity portion. In some embodiments, these portions may be referred to as cells of a hybrid cell. For example, a hybrid cell comprises a real-world entity cell, such as a cell of a captive insurance pool (as one example) and a virtual entity cell, such as virtualized computing and storage resources that have been specifically configured to provide virtualized services that support the real-world entity. For example, in the case of a real-world entity cell being a captive insurance pool cell, the virtual entity may include virtualized computing resources configured to support administering insurance policies and processing claims, amongst various other tasks specific to providing virtualized services to support the captive insurance pool cell.

In some embodiments, the hybrid real-world and virtual cell system includes a first set of computing and storage devices configured to implement one or more data stores. The one or more data stores store information for a plurality of hybrid cells, such as types of real-world entities that are included in the hybrid cells and templates for virtualized services that are to be performed to support the real-world entities of the hybrid cells. Additionally, the one or more data stores store information regarding virtualized computing and/or storage resources that are available to perform virtualized services, using respective ones of the stored templates, to support the real-world entities.

Also, the hybrid real-world and virtual cell system includes one or more computing devices configured to implement a hybrid cell inventory management system that is configured to receive, or otherwise determine, information indicative of current or future hybrid cell usage for a plurality of types of hybrid cells. For example, using the real-world example of insurance, different types of insurance lines may be required to be issued by different types of real-world entities. As an example, vehicle insurance may be required to be issued by a different entity (or a differently structured real-world cell) than other types of insurance, such as health insurance, home insurance, etc. In this example, the hybrid cell inventory management system maintains an inventory of each type of real-world cell (e.g., vehicle insurance real-world cells, health insurance real-world cells, home insurance real-world cells, etc.). Also, the received information indicative of current or future hybrid cell usage may indicate that vehicle insurance cells are being allocated to requesting tenants at a faster pace than home insurance cells, as an example. Also, the hybrid cell inventory management system may receive other types of information, such as economic data, census data, industry trends, or information from other data sources. Based on the actual usage history observed by the hybrid real-world and virtual cell service and/or the other received types of information, the hybrid cell inventory management system determines target inventory levels for each of the different types of supported hybrid cells, each type comprising a different type of real-world entity. For example, a first target inventory level may be determined for vehicle insurance hybrid cells, and a different target inventory level may be determined for health insurance hybrid cells, as an example. These determinations may be based on observed tenant usage histories for vehicle insurance hybrid cells and health insurance hybrid cells, as well as other received information, such as economic data that may include forecasts about vehicle sales or forecasts about health issues or policies, as a few examples. Since real-world entities often require regulatory approval for creation or modification, creation or modification of such real-world entities must be initiated with sufficient time for the regulatory approvals to be completed prior to real-world entities needing to be used in a hybrid cell, such as a hybrid cell to be allocated to a requesting tenant. Thus, in some embodiments, the hybrid cell inventory management system may also track regulatory approval wait times and additionally forecast future regulatory approval wait times based on past history and other received information, such as policy changes, economic conditions, etc. In some embodiments, a real-world entity of a hybrid cell, such as a captive insurance pool cell, may be approved to provide more than one type of service. For example, while vehicle insurance and health insurance are described above as belonging to different types of real-world entity cells, in some embodiments, a single real-world entity cell, such as a captive insurance pool cell, may be approved to provide more than one type of insurance (e.g., vehicle insurance and health insurance). Nevertheless, in such embodiments, different tenants may be provided different real-world entities, such as captive insurance pool cells.

In addition to determining target inventory levels to be maintained for each of the supported types of hybrid cells offered by the hybrid real-world and virtual cell service, the hybrid cell inventory management system tracks current inventory levels for each of the supported types of hybrid cells. For example, current inventory levels may be tracked in a data store of the hybrid real-world and virtual cell service. In response to determining a current or future predicted inventory level for one or more given types of hybrid cells is less than the corresponding target inventory level, the hybrid cell inventory management system initiates establishment of additional real-world entities of the given type (e.g., initiates establishment of additional vehicle insurance captive insurance pool cells or initiates establishment of additional health insurance captive insurance pool cells, as a few examples). For example, the hybrid cell inventory management system may generate notifications and/or instructions for creating the additional real-world entities and alert an administrator of the need to perform certain tasks that require human involvement to create the additional real-world entity capacity. In some embodiments, the one or more data stores may store a template for virtualized services that assist in creating the additional real-world entity capacity.

In some embodiments, an insurance pool cell comprises one or more insurance policies held in a cell of a captive. Also, in some embodiments, a virtual entity portion of a hybrid cell may be matched, for example 1:1, with a real-world entity portion of the hybrid cell. The real-world entity portion may be a captive insurance pool cell, wherein the captive insurance pool cell represents an insurance pool comprising one or more insurance policies held by the cell of the captive.

In some embodiments, the initiation of the process to establish additional real-world entity capacity may be performed by the hybrid cell inventory management system taking into account determined wait times for the establishment of different types of real-world entities. For example, for real-world entities with longer lead times, the hybrid cell inventory management system may initiate establishment of additional capacity based on future predicted inventory levels. For example, the initiation of additional capacity may be triggered based on predicted inventory levels determined for a future time, with the future time used being at a point in the future when additional capacity would be available if establishment of additional capacity is initiated in the present (e.g., taking into account wait times for regulatory approval). In other embodiments, the target inventory levels may be adjusted to account for wait times to provide a buffer to allow for delays in establishment of additional capacity.

In addition to the one or more data stores and the one or more computing devices that implement the hybrid inventory cell management system, the hybrid real-world and virtual cell system includes one or more computing devices configured to implement a hybrid cell management system. The hybrid cell management system is configured to allocate to a requesting tenant, from the maintained inventory, a real-world cell portion of a hybrid cell and also provide a complimentary virtual entity cell portion of the hybrid cell, wherein the virtual entity cell portion performs management operations for the real-world entity cell portion. As an example, a requesting tenant may request a vehicle insurance type hybrid cell. In response, the hybrid cell management system may allocate a cell of a captive insurance pool approved to provide vehicle insurance lines to customers of the requesting tenant. The requesting tenant may then issue vehicle insurance policies to the customers of the requesting tenant using the allocated cell of the captive insurance pool. However, instead of the tenant having to manage the generation of policy offers, the management of policy administration, the management of claims administration, the generation of metrics, etc., the provided virtual entity portion of the hybrid cell may automatically take care of these tasks using virtualized services automatically implemented on computing and storage resources provided by the hybrid real-world and virtual cell service, wherein the provided computing and storage resources have been specifically configured to perform the relevant tasks for the provided real-world entity cell.

For example, in some embodiments, the hybrid cell services manager selects a corresponding template from a set of templates stored in the one or more data stores, wherein the template is selected to match the type of real-world entity being supported and is further selected to include instructions for performing a particular type of task for the real-world entity being supported. For example, administering claims for vehicle insurance may include different forms, tasks, and procedures that administering claims for health insurance. Thus, in response to receiving a claim directed to a hybrid cell that is a vehicle insurance type hybrid cell, the hybrid cell service manager may select an appropriate template from the one or more data stores for processing vehicle insurance type claims. The hybrid cell services manager may also allocate compute and/or storage resources from a reserved capacity pool. The allocated compute and/or storage resources may then be configured using the template to provide the needed type of service. For example, the template may include a machine image for a virtual machine pre-configured to perform claims processing for vehicle insurance, and in response to receiving a claim directed to a hybrid cell that is a vehicle insurance type hybrid cell, the hybrid cell services manager may select the template, and boot one or more virtual machines using the machine image in the template. In some embodiments, a template may include machine images for multiple virtual machines to be used to perform a certain task or set of tasks and may further include a workflow for coordinating execution of sub-tasks between the virtual machines. As another example, instead of (or in addition to) machine images, software containers may be included or linked to the templates, and the hybrid cell services manager may deploy associated software containers to allocated computing and/or storage resources to perform a certain task or set of tasks. The software in the software containers may be executed by an allocated virtual resource, such as allocated computing capacity of a code execution service provided by a cloud-based service provider, as an example.

Note that in contrast to other types of service providers, the hybrid real-world and virtual cell service provides both the real-world cell and additionally automatically provisions a virtual entity to administer the real-world cell, without the tenant having to get involved in the details of configuring computer systems and software to administer the real-world cell. Additionally, the hybrid real-world and virtual cell service provides on-going management of the computer systems and software required to administer the real-world cell, such as automatically scaling up or scaling down computing and/or storage capacity, upgrading computing infrastructure, and upgrading administration processes to comply with all state and federal requirements, as well as industry best practices.

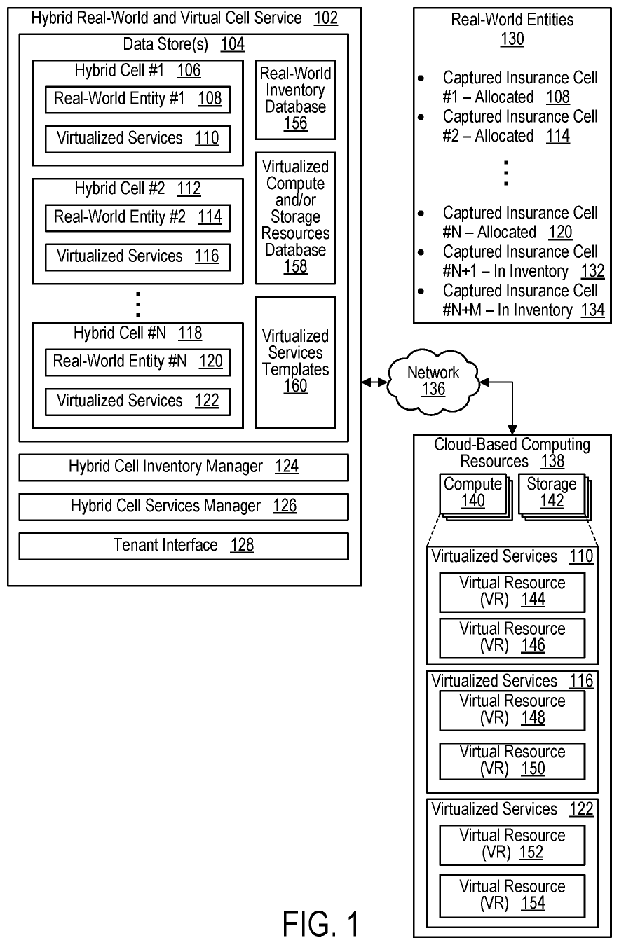

FIG. 1 is a logical block diagram illustrating a hybrid real-world and virtual cell service along with real-world entities and cloud-based computing resources that are used in hybrid cells provided by the hybrid real-world and virtual cell service, according to some embodiments.

In some embodiments, a hybrid real-world and virtual cell service, such as hybrid real-world and virtual cell service 102 includes a data store(s) 104, a hybrid cell inventory manager 124, a hybrid cell services manager 126, and a tenant interface 128.

In some embodiments, data store(s) 104 include one or more data stores, such as a data store storing information about hybrid cells of the hybrid real-world and virtual cell service 102, such as hybrid cell 106, hybrid cell 112, and hybrid cell 118. In some embodiments, hybrid real-world and virtual cell service 102 may support any number of hybrid cells and may support multiple types of hybrid cells, such as hybrid cells including different types of real-world entity portions and different types of virtualized services customized to support the different types of real-world entities. Additionally, data store(s) 104 include real-world inventory database 156, virtualized compute and/or storage resources database 158, and virtualized services templates including machine images (and/or software containers) 160.

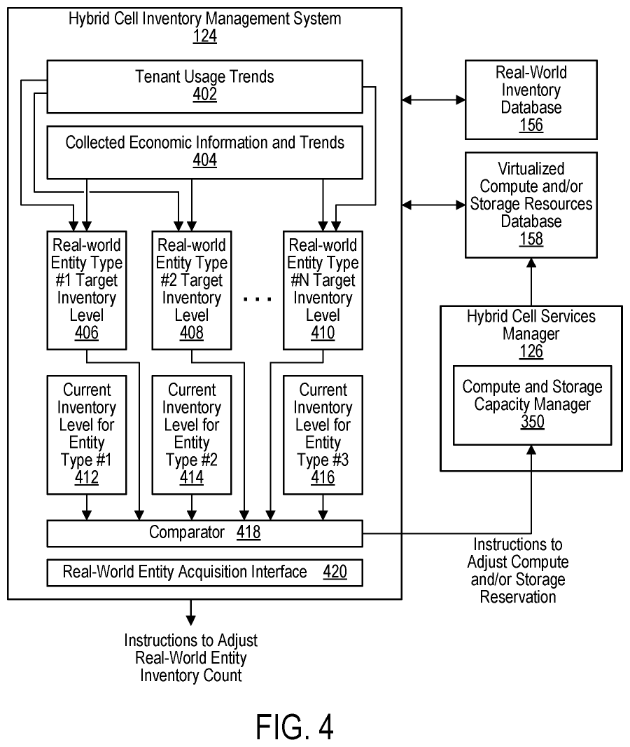

In some embodiments, real-world inventory database 156 may keep track of which of the real-world entities 130 created by the hybrid real-world and virtual cell service 102 have been allocated as parts of hybrid cells and which ones of the real-world entities 130 are held in inventory and are available to be included in a hybrid cell to be allocated to a requesting tenant. For example, real-world entity 108 of hybrid cell 106 may correspond to captured insurance cell #1 and may be shown in the real-world inventory database 156 as allocated to hybrid cell 106. As another example, real-world entity 114 of hybrid cell 112 may correspond to captured insurance cell #2 and may be shown in the real-world inventory database 156 as allocated to hybrid cell 112. As yet another example, real-world entity 120 of hybrid cell 118 may correspond to captured insurance cell #N and may be shown in the real-world inventory database 156 as allocated to hybrid cell 118. Also, other ones of real-world entities 130, such as captured insurance cell #N+1 (132) through captured insurance cell #N+M (134) may be shown in real-world inventory database 156 as being in-inventory and available to be included in a hybrid cell. As further discussed in regard to FIG. 4, hybrid cell inventory management system 124 may track respective current inventory levels for different types of real-world entities and may further determine target inventory levels for the real-world entities. Also, if inventory is less than target, hybrid cell inventory management system may initiate creation of additional real-world entities to meet the targeted inventory levels.

In some embodiments, virtualized compute and/or storage resources database 158 maintains records of reserved compute, storage, or other service capacity at cloud-based computing resources 138, which may be a third-party cloud service provider or may be cloud-based computing resources of an operator of hybrid real-world and virtual cell service 102. For example, virtualized compute and/or storage resources database 158 may keep track of a total amount of reserved compute 140 and a total amount of reserved storage 142, as well as respective amounts of the overall reserved amounts that are currently being used to implement virtual services.

For example, virtualized services 110 of hybrid cell 106 may be implemented using virtual resources 144 and 146. As an example, virtual resource 144 may be a virtual machine booted with a machine image included in a template stored in virtualized services templates 160. As another example, virtual resource 146 may be a software container implemented in a code execution environment provided by cloud-based computing resources 138. The software container may be included in a template stored in virtualized services templates 160 and may be invoked according to a workflow of the template stored in virtualized services templates 160. In some embodiments, different templates may be stored for providing virtualized services to different types of real-world entities. For example, a template for supporting a vehicle insurance type real-world entity may be different from a template for supporting a health insurance type real-world entity. As another example, virtualized services 116 of hybrid cell 112 may be implemented using virtual resources 148 and 150, which may both be virtual machines booted with respective machine images included in a template stored in virtualized services templates 160. As yet another example, virtualized services 122 of hybrid cell 118 may be implemented using virtual resources 152 and 154, both of which may be software containers executing on computing resources in a software execution environment provided by cloud-based computing resources 138.

In some embodiments, hybrid real-world and virtual cell service 102 may coordinate with cloud-based computing resources 138, via network 136, which may be a public or private network. For example, the coordination with cloud-based computing resources 138 may be provided in order to provide virtualized services 110, 116, and 122 of hybrid cells 106, 112, and 118, respectively.

In some embodiments, data store(s) 104 may additionally include datastores indicating assets and liabilities for the respective hybrid cells, and/or other accounting information. In some embodiments, credits for providers of capital to infuse the respective captive insurance cells with seed-money may be recorded in a cryptographic ledger, such as block-chain, and flows of capital into and out of the captive insurance cells may be recorded in the cryptographic ledger.

In some embodiments, an operator of the hybrid real-world and virtual cell service 102 may function as a managing general agent (MGA) for the respective allocated captive insurance cells 1 through N and also the respective in-inventory captive insurance cells N+1 through N+M.

As used herein, a captive is a user-owned insurance company. In this framework, the profit belongs to the captive owner, instead of a third-party insurance company. Captives are similar to reciprocal exchanges and mutuals. Captives are pure when the captive is wholly owned by the policyholders that are insured by the captive. Captives are sponsored when they are owned by a party unrelated to the policyholders (e.g., associations, vertical SaaS providers, etc.).

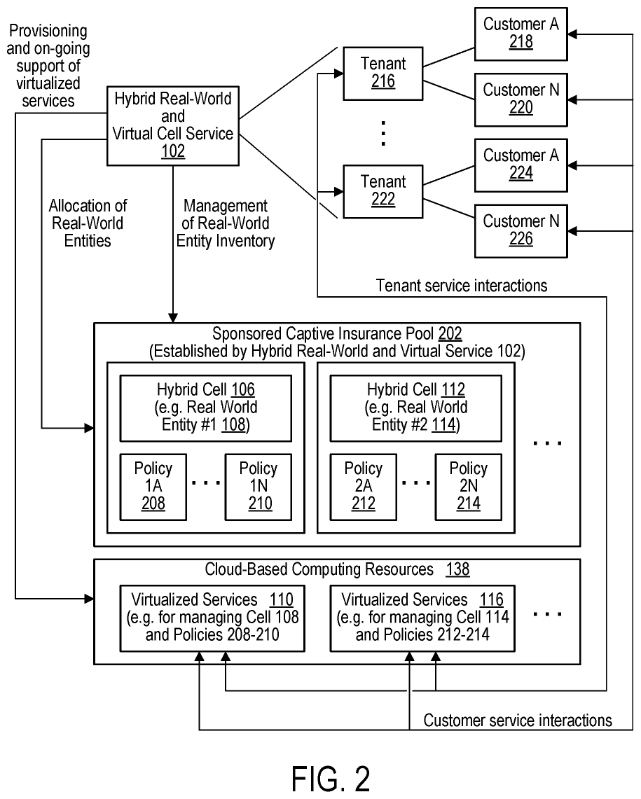

FIG. 2 is a logical block diagram illustrating an example implementation of a hybrid real-world and virtual cell service that provides hybrid cells that include real-world sponsored captive insurance pool cells, according to some embodiments.

Tenants, as described herein, may be tenants of the real-world and virtual cell service 102 and each tenant may have its own customers that are provided services of a hybrid cell allocated to a tenant. For example, hybrid cell 106 may be allocated to tenant 216 for providing vehicle insurance policies to customers 218 through 220 of tenant 216. As another example, hybrid cell 112 may be allocated to tenant 222 for providing vehicle insurance policies to customers 224 through 226. The real-world entities 108 and 114 (e.g., captured insurance cells #1 and #2) may be cells of sponsored captive insurance pool 202 that has been established by hybrid real-world and virtual cell service 102 to provide vehicle insurance type real-world entity capacity available to be allocated to tenants, such as tenants 216 and 222. In some embodiments, each of the hybrid cells may then issue policies to customers of the tenants. For example, policies 208 through 210 may be issued to customers 218 through 220 of tenant 216 and policies 212 through 214 may be issued to customers 224 through 226 of tenant 222.

As shown in FIG. 2, hybrid real-world and virtual cell service 102 may perform management of sponsored captive insurance pool 202, such as creating the pool, performing administrative tasks for the pool, and completing regulatory compliance tasks for the pool. Additionally, hybrid real-world and virtual cell service 102 may allocate cells of the pool (e.g., real-world entities) to tenants of the hybrid real-world and virtual cell service 102, in order to enable the tenants to provide services in the name of a real-world entity for customers, such as providing insurance policies 208 through 210 and 212 through 214 to customers 218 through 220 and 224 through 226, wherein the insurance policies are issued under the respective captive insurance cells 108 and 114 of sponsored captive insurance pool 202.

Also, in addition to providing the real-world entities, such as sponsored captive insurance cells 108 and 114 to tenants 216 and 222, hybrid real-world and virtual cell service 102 also provides virtual services 110 for managing hybrid cell 106 and policies 208-210 and provides virtual services 116 for managing hybrid cell 116 and policies 212-214. For example, customers 218-220 of tenant 216 and customers 224-226 of tenant 222 may issue customer service interactions to virtualized services 110 and 116, which will respond to the customer service interactions automatically on behalf of tenants 216 and 222, without tenants 216 and 222 having to manage (or otherwise deal with) the customer service interactions. For example, issuance of policies 208-210 and policies 212-214 may be automatically performed by virtualized services 110 and 116. Also, processing of claims against policies 208-210 and claims against policies 212-214 may be automatically processed by virtualized services 110 and 116. All of this may be automatically implemented, managed, and scaled up or down by hybrid cell services manager 126 of hybrid real-world and virtual cell service 102, without requiring direct interaction or management from tenants 216 and 222.

Also, tenant service interactions, such as inquiring about capital balances, risk profiles, and/or other metrics may be automatically serviced by virtualized services 110 and 116, wherein virtualized services 110 and 116 are implemented using compute resources 146 and storage resources 148 of cloud-based computing resources 138, that have been reserved (or owned) by hybrid real-world and virtual cell service 102, and which have been allocated to hybrid cells 106 and 112 and implemented using templates from virtualized services templates storage 160 in order to provide customized virtualized services 110 and 116 that are customized to compliment real-world entities 108 and 114.

In some embodiments, a requesting tenant (e.g., a potential tenant requesting allocation of a hybrid cell) may provide, to a user interface of the hybrid real-world and virtual cell service 102, such as tenant interface 128, a tenant selection of a given type of real-world entity cell to be allocated to the requesting tenant. In response, the hybrid real-world and virtual cell service 102 allocates, to the requesting tenant, a given one of the real-world entity cells of the given type (such as real-world entity cell 108 or 114) from an inventory of real-world entity cells of the given type maintained by hybrid cell inventory manager 126. Also, in response, the hybrid real-world and virtual cell service 102 provides a complimentary virtual entity cell for the given real world entity cell (such as virtualized services 110 or 116), wherein providing the complimentary virtual entity cell comprises instantiating one or more virtual resources (such as VRs 144 and 146 or VRs 148 and 150) using one or more of the stored templates (such as those stored in virtualized services templates 160), wherein the one or more virtual resources, when instantiated using the one or more stored templates, are configured to perform management operations for managing the real-world entity cells of the given type.

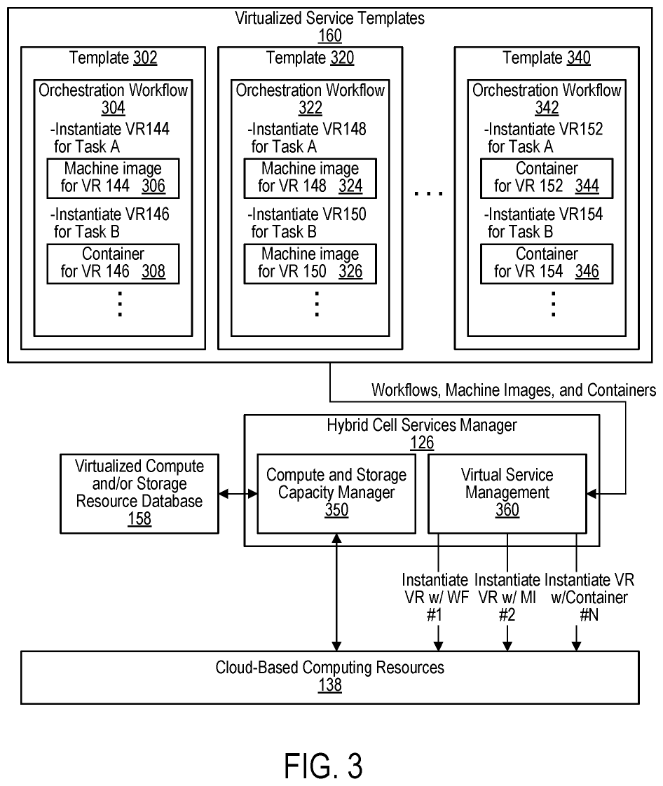

FIG. 3 is a logical block diagram illustrating templates used by a hybrid real-world and virtual cell service to provide virtual services that are matched to a type of real-world entity being provided in the hybrid real-world and virtual cell, according to some embodiments.

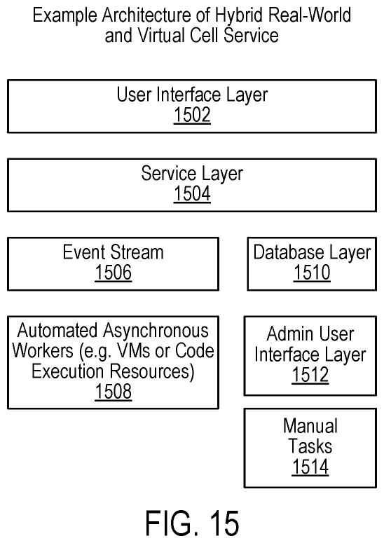

In some embodiments, templates stored in virtualized services templates storage 160 may include templates, such as templates 302, 320, and 340. In some embodiments, such templates may include a workflow for providing virtualized services, such as virtualized services 110, 116, and 122. In some embodiments, providing the virtualized services may involve using one or more virtualized resources. Also, in some embodiments, various types of virtualized resources may be used, such as virtual machines booted with machine images stored in the templates, or software containers stored in the templates that are executed using a software execution service, such as Kubernetes service, as an example. In some embodiments, a workflow for implementing a virtualized service may include software containers for performing some tasks of the workflow and machine images for use in booting virtual machines that will perform other tasks of the workflow. In some embodiments, a workflow manager may coordinate other worker nodes that perform tasks of the workflow. For example, FIG. 15 illustrates an example architecture, wherein events of an event stream are processed by automated asynchronous workers 1508.

As an example, template 302 includes orchestration workflow 304 for implementing virtualized services 110, wherein the workflow 304 includes instantiating virtual resource 144 for task A using machine image 306 included in template 302 and also instantiating virtual resource 146 for task B using container 308 included in template 302. As another example, template 320 includes orchestration workflow 322 for implementing virtualized services 116, wherein the workflow 322 includes instantiating virtual resource 148 for task A using machine image 324 included in template 320 and instantiating virtual resource 150 for task B using machine image 326 included in template 320. As yet another example, template 340 includes orchestration workflow 342 for implementing virtualized services 122, wherein the workflow 342 includes instantiating virtual resource 152 for task A using container 344 included in template 340 and instantiating virtual resource 154 for task B using container 346 included in template 340.

In some embodiments, virtual service management 360 of hybrid cell services manager 126 selects which template to access from the virtualized services templates storage 160 based on a type of virtualized service to be offered and a type of real-world entity the virtualized service is to support. Based on the selection of the correct template, the virtual service management 360 may retrieve the appropriate workflow, machine images, and containers for orchestrating the respective virtualized service. Also, compute and storage capacity manager 350 may allocate compute and storage resources from a pool of reserved resources at cloud-based computing resources 138 in order to implement the virtualized service using the appropriate workflows, machine images, and containers, based on the selection. Also, as compute and storage resources are allocated, compute and storage capacity manager may update virtualized compute and storage resources database 158 to reflect a current level of available reserved compute and storage capacity. If the available reserved compute and/or storage capacity is less than a threshold, the compute and storage capacity manager 350 may automatically request an increased reservation from cloud-based computing resources 138.

Also, as shown in FIG. 3, the virtual service management 360 may provide instructions to cloud-based computing resources 138 to instantiate the respective virtual resources using the retrieved workflows, machine images, and/or containers.

For example, virtual service management 360 may cause program instructions included in respective ones of the templates (e.g., such as may be included in workflows, machine images, containers) to be executed to configure reserved computing and/or storage capacity of a cloud-based service provider, such as cloud-based computing resources 138, to provide a complimentary virtual entity cell for a given real-world entity cell.

In some embodiments, compute and storage capacity manager 350 may monitor performance of the one or more virtual resources using allocated computing and/or storage capacity at the cloud-based service provider and automatically scale up or scale down the allocated computing and/or storage capacity based on the monitored performance.

FIG. 4 is a logical block diagram illustrating additional details regarding a hybrid cell inventory management system included in the hybrid real-world and virtual cell service, according to some embodiments.

In some embodiments, a hybrid cell inventory management system, such as hybrid inventory management system 124, includes an interface for receiving, or a module for generating, tenant usage trends 402, and may also include an interface for receiving, collected economic information and trends 404, which may include economic information, policy information, news information, and/or various other types of data relevant to forecasting future real-world inventory demand. While, not shown, in some embodiments, hybrid cell management system 124 may further include a network interface for receiving the collected economic information and trends 404. In some embodiments, tenant usage trends 402 may be received from real-world inventory database 156 or may be generated by hybrid cell inventory management system 124 using information retrieved from real-world inventory database 156. Also, usage trends may be received (or generated) from information included in virtualized compute and/or storage resources database 158.

The tenant usage trends 402 and the collected economic information and trends 404 may be used to determine target inventory levels for a plurality of types of hybrid cells (comprising different types of real-world entities). For example, target inventory levels 406, 408, and 410 may be determined for real-world entity types 1, 2, and N. Also, current inventory levels 412, 414, and 416 are determined. Comparator 418 compares the target inventory levels to the current inventory levels, and may further take into account a wait time for acquiring additional real-world entity capacity in order to determine instructions to adjust real-world inventory counts. Comparator 418 may also provide instructions to increase or a decrease compute and/or storage reservations. The compute and storage capacity instructions may be provided to compute and storage capacity manager 350, who adjusts reservations with cloud-based computing resource provider 138 and updates the virtualized compute and/or storage resources database 158, accordingly.

In some embodiments, the instructions to adjust the real-world entity inventory count may be provided to real-world entity acquisition interface 420, which in some embodiments may be implemented using an administrator user interface layer, such as administrator user interface layer 1512 shown in FIG. 15, wherein real-world people assist in performing manual tasks 1514 in order to acquire more real-world entities. In some embodiments, a virtual resource may be provided to assist the real-world people in acquiring the additional real-world entities. For example, virtualized services may assist by providing and filling out forms, etc.

In some instances, wherein the real-world entity is a captive insurance company, wait times for acquiring additional real-world entities may be long. For example, the process of setting up a captive insurance company is laborious and cumbersome. Even with knowledge of insurance, establishing a captive necessitates several third parties (for legal reasons) including managing general agent functionality. The status quo for establishing a captive is detailed below:
1. First, it is necessary to determine whether to create a:
   a. Single-Parent Captive
   b. Association Captive
   c. Risk Retention Group
   d. Agency Captive
   e. 831 (b) Captive
   f. Protected Cell Captive
2. Next, it is necessary to work with an independent party to conduct a feasibility study, examining the risk profile of potential policies and create a business plan to achieve an initial price for each policy.
3. Next, it is necessary to retain a captive manager who will oversee accounting, actuarial responsibilities, claims management, domiciliary, and regulatory issues, investment management, pricing and underwriting, tax implications, and finally assess which of the possible seventy captive domiciles worldwide would be most appropriate.
4. Finally, it is necessary to work with the captive manager to complete all necessary paperwork and submit all of this information to a chosen domicile (upon completion, approvals typically take ninety days or more).

However, a hybrid cell inventory management system may perform these tasks ahead of time on behalf of tenants. Also, a hybrid cell inventory management system may maintain a variety of types of captive pools in a variety of domiciles that a requesting tenant can choose from. For example, hybrid real-world and virtual cell service 102 may set up a protected cell captive insurance program and perform the required actuarial, legal and regulatory analysis and licensing in advance for certain types of entities, sponsors, and communities, so that a requesting tenant can establish a captive as a cell within the existing segregated cell captive. Also, the hybrid real-world and virtual cell service 102 provides a multi-tenant technology platform for creating and maintaining pure and sponsored captives that are either cells within the segregated cell captive, or are separate pure captives, such as for more sophisticated sponsors and policyholders (e.g., for more sophisticated requesting tenants and customers of the requesting tenants).

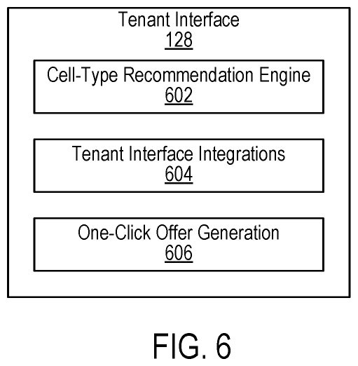

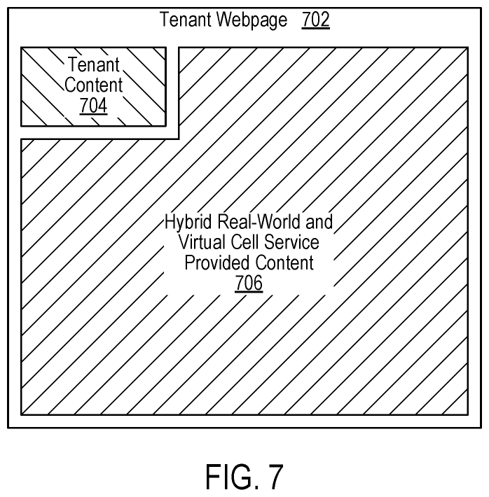

In some embodiments, the hybrid real-world and virtual cell service 102 acts as a single entity that performs both the management of the captive and the administration and servicing of the policies within those captives in the capacity of a carrier or a managing general agent (MGA). The structure proposed works for both sponsored and pure captives. Although the scheme described above uses a protected cell captive, the same idea can be applied when the whole captive (segregated cell or otherwise) is owned by the sponsor/policyholders but is managed and administered by the captive manager, e.g., the hybrid real-world and virtual cell service 102. The tenant of the hybrid real-world and virtual cell service 102 can be integrated into an existing platform or application through a redirection workflow into their tenant, an API integration, or through an iframe, such as described in more detail with regard to tenant interface 128 discussed in FIG. 6 and the example interface arrangements shown in FIGS. 7-9.

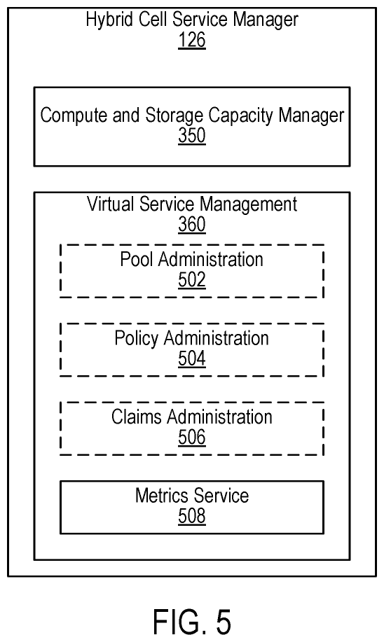

FIG. 5 is a logical block diagram illustrating additional details regarding a hybrid cell service manager included in the hybrid real-world and virtual cell service, according to some embodiments.

In some embodiments, each community pool is an isolated unit of risk and can be a cell within a segregated cell captive, or a captive by itself. Each community pool (or cell) is provided to a requesting tenant and is represented as a tenant within the hybrid real-world and virtual cell service. Also, each tenant comes with its own insurance software stack to administer and service insurance policies of the tenant. In some embodiments, the insurance software stack includes policy administration, claims administration, pool administration, and a metrics service.

As discussed in FIG. 3, hybrid cell service manager 126 includes compute and storage capacity manager 350 and virtual service management 360. In some embodiments, virtual service management 360 may further include a pool administration agent 502, a policy administration agent 504, a claims administration agent 506, and a metrics service 508. In some embodiments, the respective agents and metric service may be implemented using machine images and/or containers referenced in workflows of templates, such as the templates described in FIG. 3.

In some embodiments, pool administration agent 502 maintains information about the policyholders in the pool. It combines information from the policy administration agent 504 and the claims administration agent 506 to compute how much of a premium is left over after claims are paid. The pool administration agent 502 also controls whether the leftover premium is paid back to the customer of the tenant in the form of a dividend or if it is carried over as a credit when the policyholder (e.g., customer of the tenant) renews the policy depending on the choice of the customer and/or tenant. The pool administration agent 502 can also have a feature to allow a tenant to allow or deny any customer from purchasing policies within the pool. The pool administration service also determines whether a pool is active or not. An active pool is a pool that is able and allowed to sell policies.

In some embodiments, policy administration agent 504 allows a customer to purchase an insurance policy from a community pool. The customer becomes a part of the pool when they successfully purchase a policy from the pool. The policy administration agent 504 is configured with several products that can be offered to any customer within the pool. In order to purchase a policy, a customer interacts with the policy administration agent 504 and chooses which product the customer requires. Depending on the customer's choice of product, the policy administration agent 504 collects information from the customer that is required to underwrite the risk the customer represents within the community pool. Based on this information, the underwriting rules defined in a template for the policy administration can choose whether to provide the customer a quote or deny the customer a policy. If provided with a quote, the customer can choose to purchase the quoted product and become a policyholder in the community pool. In some embodiments, the policy administration agent 504 is used for underwriting the risk, assigning a premium to the policy, and collecting payments required for the policy.

In some embodiments, claims administration agent 506 allows a policyholder to file a monetary claim against their insurance policy when a qualifying event occurs. When a policyholder files a claim, they provide a reference to their insurance policy within the pool and all data that is relevant to evaluating the qualifying event. The claims administration agent 506 evaluates the data against the terms of the insurance policy to either approve or reject the claim. The claims administration agent 506 is also responsible for ensuring that the amount of a claim is paid out in case the claim is approved.

In some embodiments, the metrics service 508 aggregates data about the pool and reports it to the tenant. The report may be in the form of an email, physical mail, or a dashboard. Some metrics that are aggregated by the metrics service 508 include: (1) a number of policyholders in the pool; (2) a number of policies underwritten by the pool; (3) an amount of premiums paid into the pool; and/or (4) an amount of money related to claims released from the pool. In some embodiments, other pertinent metrics may be provided.

In some embodiments, the agents of the virtual service management 360 may automatically issue new polices to customers of the requesting tenant, wherein tasks of issuance are performed, at least in part, by the one or more virtual resources. Also, the agents of the virtual service management 360 automatically administer claims submitted by customers of the tenant, wherein tasks of claim administration are performed, at least in part, by the one or more virtual resources.

FIG. 6 is a logical block diagram illustrating additional details regarding a tenant interface included in the hybrid real-world and virtual cell service, according to some embodiments.

In some embodiments, tenant interface 128 may include cell-type recommendation engine 602, tenant interface integrations 604, and one-click offer generation 606.

In some embodiments, cell-type recommendation engine 602 receives information from a requesting tenant regarding types of risks and/or types of potential customers of the requesting tenant and makes a recommendation to the requesting tenant of a type of pure captive insurance pool or a type of sponsored captive insurance pool that is to be used for the requesting tenant's real world entity cell.

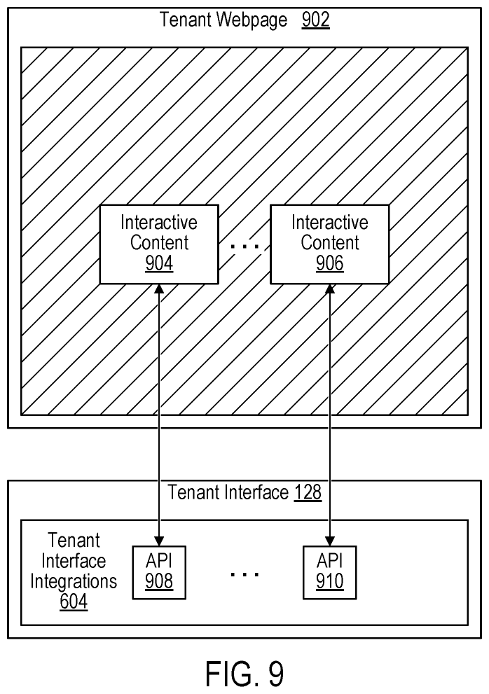

In some embodiments, tenant interface integrations 604 may implement the various webpage integrations shown in FIGS. 7-9. For example, tenant interface integrations 604 may implement, at one or more virtual resources, one or more application programmatic interfaces (APIs) for receiving queries relayed to the one or more virtual resources from an existing user interface of a tenant. The tenant interface integrations 604 may also provide, to the tenant, program instructions for incorporating user interface elements into the existing user interface of the tenant, wherein the user interface elements to be included in the existing user interface of the tenant are configured to generate the queries relayed to the APIs of the one or more virtual resources. For example, FIG. 9 illustrates interactive content 904 and 906 embedded in tenant webpage 902, wherein the interactive content 904 and 906 sends and receives packets to and from the APIs 908 and 910 of the tenant interface integrations 604.

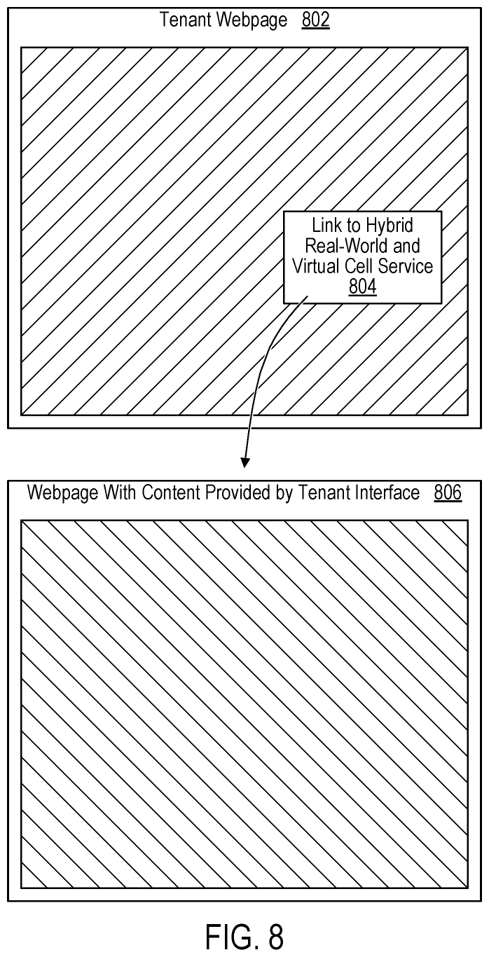

Alternatively, the tenant interface integrations 604 may provide, to a tenant, program instructions for incorporating user interface elements into an existing user interface of the tenant, wherein the user interface elements to be included in the existing user interface of the tenant are configured to redirect a customer of the requesting tenant to a user interface implemented via the one or more virtual resources. For example, FIG. 8 illustrates a link 804 to a webpage 806 with content provided by the real-world and virtual cell service 102 that is embedded in tenant webpage 802.

As another example, in some embodiments, tenant interface integrations 604 may provide program instructions to a tenant for implementing an iframe, such as shown in FIG. 7, wherein hybrid real-world and virtual cell service provided content 706 is incorporated into tenant webpage 702 along with tenant content 704.

In some embodiments, one-click offer generation 606 receives, from a requesting tenant, information about potential customers of the requesting tenant and selects a given one or more of the stored templates to be used to instantiate the one or more virtual resources based on the potential customer information. The one-click offer generation 606 may also identify in one or more public data sources additional information about the potential customers of the requesting tenant. Based on the received and identified information about the potential customers, the one-click offer generation 606 further generates, using the one or more virtual resources, offers for services to be provided, by the requesting tenant, to the potential customers of the requesting tenant, using a hybrid cell, wherein the offers are generated based on the received information from the requesting tenant about the potential customers and the identified public data about the potential customers. The offers are “one-click” offers that are configured to be accepted, to implement a service of a service type of the hybrid cell for the potential customers of the requesting tenant, in response to a single indication of acceptance (e.g., click) by a given customer without requiring the given customer to supply additional customer information. For example, a community sponsor (e.g., tenant) can provide a list of qualified leads to invite into their community. The one-click offer generation 606 collects information about the potential customers of the tenant that is relevant for underwriting from the tenant's database, public databases (DMV, OSHA, Small Business Loans etc.), and other private data sources to generate an insurance quote that is sent to the potential customer directly, either through email, embedded into the tenant's systems, etc. The potential customer can then simply review their information and quoted price and proceed to pay for their insurance. Additionally, the one-click offer generator 606 may identify specific risk characteristics, which are sufficient to generate an insurance quote without any additional questions to the potential customer.

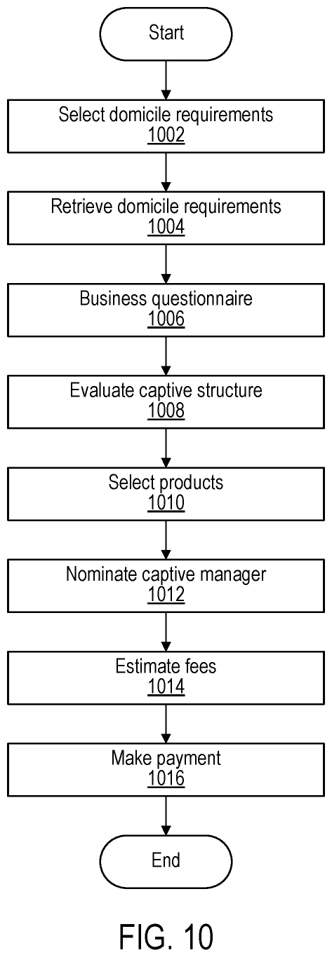

FIG. 10 illustrates an example process executed by a hybrid real-world and virtual cell service to add additional real-world entity capacity via creation of an additional captive insurance pool, according to some embodiments.

In some embodiments, a real-world entity, such as an insurance company, may be incorporated as a protected cell captive insurance company where a program manager serves as a captive sponsor (for example an operator of hybrid real-world and virtual cell service 102 may function as a captive sponsor). A captive sponsor is different from a community sponsor (e.g., tenant). The captive sponsor is required to perform the administrative functions required to maintain the protected cell captive insurance company including periodic reporting of the performance of the cells within the captive, providing surplus capital, performing a feasibility study etc. A community sponsor (e.g., tenant) is required to perform all of the administrative functions for a community pool that resides as a cell within the captive. However, instead of performing these tasks themselves, the community sponsor may rely on virtualized services offered by the hybrid real-world and virtual cell service 102 to also perform these tasks.

When a captive is domiciled, the captive is already approved for a specific number of cells and the kinds of exposures that the cell can insure. A pool service (such as pool administration 502) contains information in its database about the captive, the cells within the captive, the status of the cells, and the nature of the exposures that can be insured by the cells. When a community sponsor (e.g., tenant) wants to create a community pool, they interact with the pool service and request that a cell is allocated within the captive program. The requesting tenant provides information about the exposures that will be insured by the cell. If an existing cell is approved to insure against the kind of exposure that the requesting tenant wants to insure and if the cell is not previously assigned to another tenant, then the cell is assigned to a tenant contingent on the tenant signing a participant contract and providing the relevant fee for incorporating the cell.

If such a cell is not present within the existing captive structure, then the pool service (such as pool administration 502) requests additional information required to incorporate the cell. Based on where the captive is domiciled, the pool service (such as pool administration 502) performs the necessary actions required to incorporate the cell within the captive. If the pool service determines that the incorporation of the cell requires additional actuarial or accounting review, a human operator is alerted to perform those functions and provide the additional documentation before it is forwarded to a governmental regulator. The pool service also keeps track of the status of the captive formation request and alerts the requesting tenant that the captive is now incorporated and the community pool is created. A similar mechanism can also be extended for creating similar insurance infrastructure including but not limited to mutuals, reciprocals, and other kinds of captives.

For example, in some embodiments the steps shown in FIG. 10 may be used to create a pool. For example, at block 1002, domicile requirements are selected or determined. At block 1004 information needed to satisfy the domicile requirements is obtained. At block 1006 a business questionnaire required by a governmental agency for approval is completed. Also, at block 1008 captive structure options are evaluated and, at block 1010, based on the evaluation, products to be offered are selected. At block 1012, a captive manager (e.g., agent of the hybrid real-world and virtual cell service) is nominated as a captive manager of the pool. At block 1014, fees for creating the pool are estimated, and, at block 1016, the fees are paid.

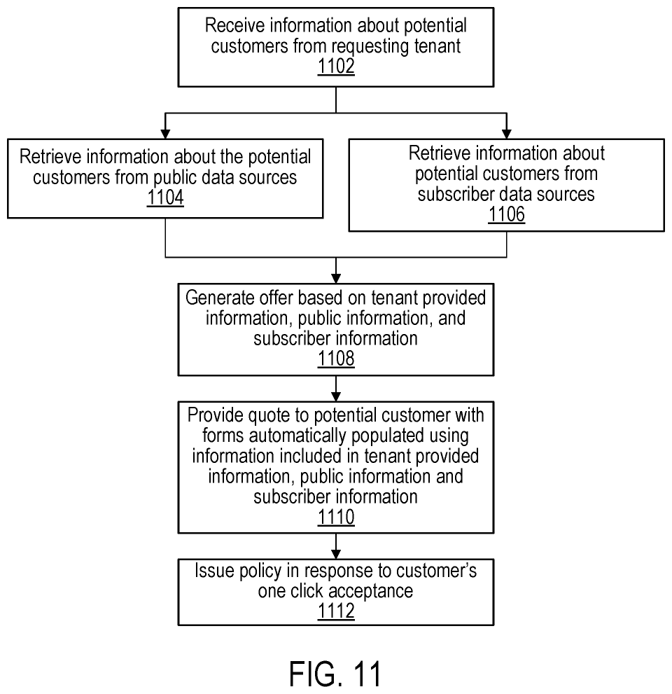

FIG. 11 is a flow diagram illustrating a process executed by a hybrid real-world and virtual cell service to provide one click acceptance products to customers of tenants of the hybrid real-world and virtual cell service, according to some embodiments.

At block 1102, the hybrid real-world and virtual cell service receives information about potential customers from requesting tenant. At block 1104, the hybrid real-world and virtual cell service retrieves information about the potential customers from public data sources, and, at block 1106, retrieves information about the penitential customers from private data sources, such as subscription data sources.

At block 1108, the hybrid real-world and virtual cell service generates an offer based on the tenant provided information about the potential customer, public information retrieved about the potential customer, and/or subscription information retrieved from a private data source about the customer.

At block 1110, the quote is provided to the potential customer with all necessary forms pre-populated with the information retrieved at blocks 1104 and 1106 and received at block 1102.

At block 1112, a policy is issued to the potential customer in response to the customer's acceptance, which may involve minimal acceptance requirements by the potential customer, such as a one or only a few clicks of a mouse or other user interface element, such as taps on a screen.

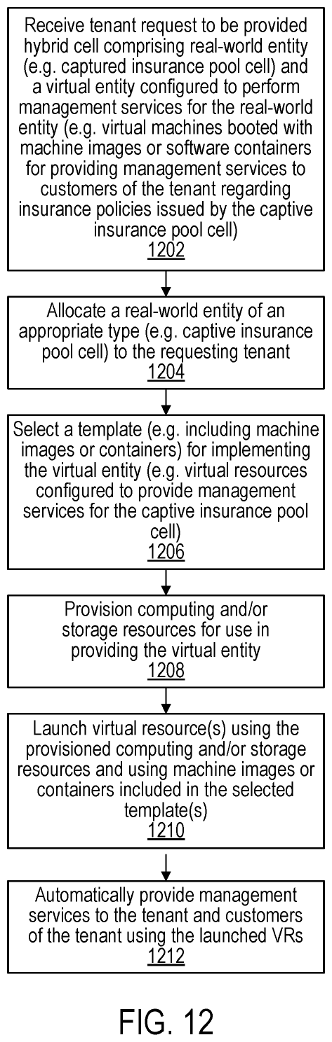

FIG. 12 is a flow diagram illustrating a process executed by a hybrid real-world and virtual cell service to provide a hybrid cell to a requesting tenant of the hybrid real-world and virtual cell service, according to some embodiments.

At block 1202, a hybrid real-world and virtual cell service receives a tenant request to be provided a hybrid cell comprising a real-world entity (e.g., captured insurance pool cell) and a virtual entity configured to perform management services for the real-world entity (e.g., virtual machines booted with machine images or software containers for providing management services to customers of the tenant regarding insurance policies issued by the captive insurance pool cell).

At block 1204, the hybrid real-world and virtual cell service allocates a real-world entity of an appropriate type (e.g., captive insurance pool cell) to the requesting tenant. Also, at block 1206, the hybrid real-world and virtual cell service selects a template (e.g., including machine images or containers) for implementing the virtual entity (e.g., virtual resources configured to provide management services for the captive insurance pool cell). Also, at block 1208, the hybrid real-world and virtual cell service provisions computing and/or storage resources for use in providing the virtual entity, and, at block 1210, launches the virtual resources using the provisioned computing and/or storage resources and using machine images or containers included in the selected template(s).

At block 1212, the hybrid real-world and virtual cell service automatically provides management services to the tenant and customers of the tenant using the launched virtual resources.

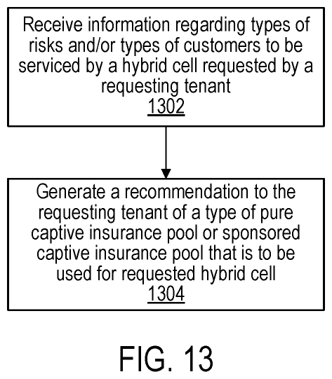

FIG. 13 is a flow diagram illustrating a process executed by a hybrid real-world and virtual cell service to provide a requesting tenant a recommendation regarding a type of hybrid cell to use to provide real-world and virtual services to customers of the tenant, according to some embodiments.

At block 1302, a hybrid real-world and virtual cell service receives information regarding types of risks and/or types of customers to be serviced by a hybrid cell requested by a requesting tenant and, at block 1304, generates a recommendation to the requesting tenant of a type of pure captive insurance pool or sponsored captive insurance pool that is to be used for requested hybrid cell.

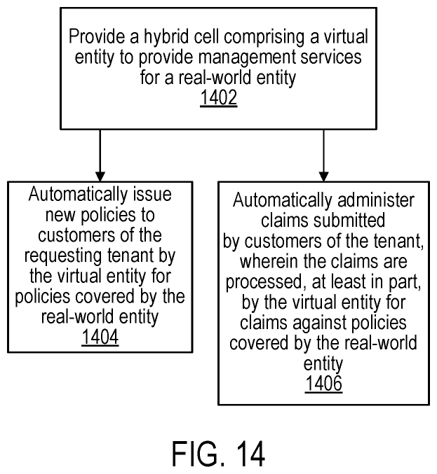

FIG. 14 is a flow diagram illustrating a process executed by a hybrid real-world and virtual cell service to provide virtualized services to customers of a tenant, according to some embodiments.

At block 1402, a hybrid real-world and virtual cell service provides a hybrid cell comprising a virtual entity to provide management services for a real-world entity. Then at block 1404, the hybrid real-world and virtual cell automatically issues, according to tenant defined criteria, new policies to customers of the requesting tenant for policies covered by the real-world entity. Also, at block 1406, the hybrid real-world and virtual cell service automatically administers claims submitted by customers of the tenant, wherein the claims are processed, at least in part, by the virtual entity for claims against policies covered by the real-world entity.

FIG. 15 illustrates an example architecture of a hybrid real-world and virtual cell service, according to some embodiments.

In some embodiments, an architecture for implanting the various components of the hybrid real-world and virtual cell service may be organized as a user interface layer 1502, a services layer 1054, wherein the service layer forwards tasks on to an event stream 1506, which implements automated asynchronous workers 1508, such as described above with regard to virtualized services. Also, service layer 1504 interacts with a database layer 1510 (e.g., data store(s) 104). Also, manual tasks 1514 may be performed via an administrator user interface layer 1512. In some embodiments, the database layer 1510 may publish events to the event stream 1506 based on user interactions. For example, when a requesting tenant interacts with the service via user interface layer 1502, a new tenant request entry may be added to database layer 1510, and the database layer 1510 may publish an event to the event stream 1506, which the causes an automated asynchronous worker 1508 to be assigned a task indicated in the event published to the event stream 1506.

### Example Computer System

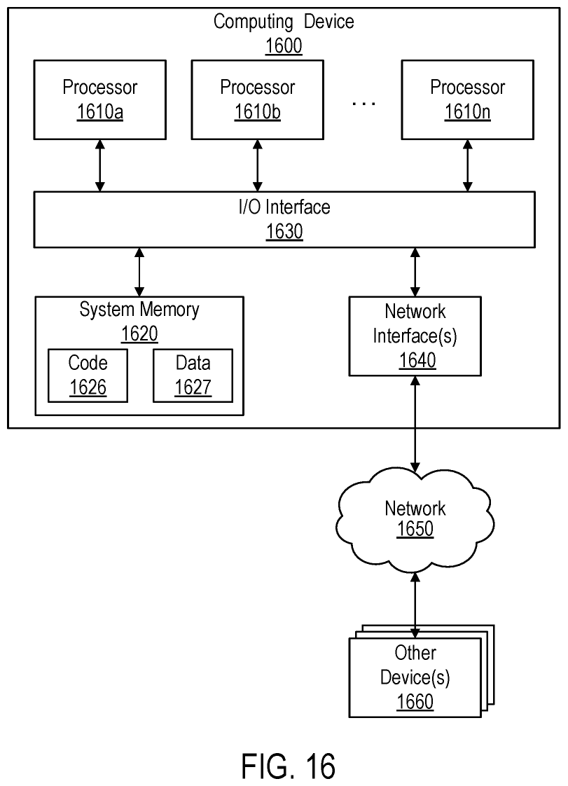

The hybrid real-world and virtual cell service described above may in some embodiments be implemented by any combination of hardware and software, for instance, a computer system or computing device 1600 as in FIG. 16 that includes one or more processors executing program instructions stored on a computer-readable storage medium coupled to the processors. In the illustrated embodiment, computer system 1600 includes one or more processors 1610 coupled to a system memory 1620 via an input/output (I/O) interface 1630. Computer system 1600 further includes a network interface 1640 coupled to I/O interface 1630. While FIG. 16 shows computer system 1600 as a single computing device, in various embodiments a computer system 1600 may include one computing device or any number of computing devices configured to work together as a single computer system 1600.

In various embodiments, computer system 1600 may be a uniprocessor system including one processor 1610, or a multiprocessor system including several processors 1610 (e.g., two, four, eight, or another suitable number). Processors 1610 may be any suitable processors capable of executing instructions. For example, in various embodiments, processors 1610 may be general-purpose or embedded processors implementing any of a variety of instruction set architectures (ISAs), such as the x86, PowerPC, SPARC, or MIPS ISAs, or any other suitable ISA. In multiprocessor systems, each of processors 1610 may commonly, but not necessarily, implement the same ISA.

System memory 1620 may be one embodiment of a computer-accessible medium configured to store instructions and data accessible by processor(s) 1610. In various embodiments, system memory 1620 may be implemented using any non-transitory storage media or memory media, such as magnetic or optical media, e.g., disk or DVD/CD coupled to computer system 1600 via I/O interface 1630. A non-transitory computer-accessible storage medium may also include any volatile or non-volatile media such as RAM (e.g., SDRAM, DDR SDRAM, RDRAM, SRAM, etc.), ROM, etc., that may be included in some embodiments of computer system 1600 as system memory 1620 or another type of memory. Further, a computer-accessible medium may include transmission media or signals such as electrical, electromagnetic, or digital signals, conveyed via a communication medium such as a network and/or a wireless link, such as may be implemented via network interface 1340. In the illustrated embodiment, program instructions (e.g., code) and data implementing one or more desired functions, such as the hybrid real-world and virtual cell service systems described above, are shown stored within system memory 1630 as code 1626 and data 1627.

In one embodiment, I/O interface 1630 may be configured to coordinate I/O traffic between processor 1610, system memory 1620, and any peripheral devices in the device, including network interface 1640 or other peripheral interfaces. In some embodiments, I/O interface 1630 may perform any necessary protocol, timing or other data transformations to convert data signals from one component (e.g., system memory 1620) into a format suitable for use by another component (e.g., processor 1610). In some embodiments, I/O interface 1630 may include support for devices attached through various types of peripheral buses, such as a variant of the Peripheral Component Interconnect (PCI) bus standard or the Universal Serial Bus (USB) standard, for example. In some embodiments, the function of I/O interface 1630 may be split into two or more separate components, such as a north bridge and a south bridge, for example. Also, in some embodiments some or all of the functionality of I/O interface 1630, such as an interface to system memory 1620, may be incorporated directly into processor 1610.

Network interface 1640 may be configured to allow data to be exchanged between computer system 1600 and other devices 1660 attached to a network or networks 1650. In various embodiments, network interface 1640 may support communication via any suitable wired or wireless general data networks, such as types of Ethernet network, for example. Additionally, network interface 1640 may support communication via telecommunications/telephony networks such as analog voice networks or digital fiber communications networks, via storage area networks such as Fiber Channel SANs, or via any other suitable type of network and/or protocol.

In some embodiments, system memory 1620 may be one embodiment of a computer-accessible medium configured to store program instructions and data as described above for FIGS. 1-15. Generally speaking, a computer-accessible medium may include non-transitory storage media or memory media such as magnetic or optical media, e.g., disk or DVD/CD coupled to computer system 1600 via I/O interface 1630. A non-transitory computer-accessible storage medium may also include any volatile or non-volatile media such as RAM (e.g., SDRAM, DDR SDRAM, RDRAM, SRAM, etc.), ROM, etc., that may be included in some embodiments of computer system 1600 as system memory 1620 or another type of memory. Further, a computer-accessible medium may include transmission media or signals such as electrical, electromagnetic, or digital signals, conveyed via a communication medium such as a network and/or a wireless link, such as may be implemented via network interface 1640.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g., SDRAM, DDR, RDRAM, SRAM, etc.), ROM, etc., as well as transmission media or signals such as electrical, electromagnetic, or digital signals, conveyed via a communication medium such as network and/or a wireless link.

The various systems and methods as illustrated in the figures and described herein represent example embodiments of methods. The systems and methods may be implemented manually, in software, in hardware, or in a combination thereof. The order of any method may be changed, and various elements may be added, reordered, combined, omitted, modified, etc.

Although the embodiments above have been described in considerable detail, numerous variations and modifications may be made as would become apparent to those skilled in the art once the above disclosure is fully appreciated. It is intended that the following claims be interpreted to embrace all such modifications and changes and, accordingly.

What is claimed is:

1. A system, comprising:
a data store storing information for a plurality of hybrid cells, the hybrid cells comprising a real-world entity cell and a complimentary virtual entity cell, wherein the hybrid cells are configured to be provisioned to tenants for use in providing a plurality of types of services to customers of the tenants;
one or more computing devices configured to implement a hybrid cell inventory management system, the hybrid cell inventory management system configured to:
receive information indicative of current or future hybrid cell usage levels for a plurality of types of hybrid cells;
determine target inventory levels to be maintained for each of the plurality of types of hybrid cells, wherein different ones of the types of hybrid cells are used to provide different ones of the plurality of types of services to the customers of the tenants; and
for one or more of the types of hybrid cells for which an inventory level is less than its respective target inventory level, initiate establishment of additional real-world entity cells of a type corresponding to the respective hybrid cell type for which the inventory level is less than its respective target inventory level; and
one or more computing devices configured to implement a hybrid cell management system configured to:
allocate, to a requesting tenant, a given one of the respective real-world entity cells for a requested hybrid cell of a given type; and
provide a corresponding complimentary virtual entity cell for the requested hybrid cell of the given type, wherein the complimentary virtual entity cell performs management operations for the real-world entity cell of the hybrid cell of the given type.

2. The system of claim 1, wherein the one or more computing devices configured to implement the hybrid cell management system are further configured to:
store a plurality of templates for implementing a plurality of types of complimentary virtual entity cells for a plurality of types of real-word entity cells corresponding to the plurality of types of hybrid cells;
receive, via a user interface of the system, a tenant selection of a given type of real-world entity cell to be allocated to the requesting tenant;
allocate, to the requesting tenant, a given one of the real-world entity cells of the given type from an inventory of real-world entity cells of the given type maintained by the hybrid cell inventory management system; and
provide the complimentary virtual entity cell for the given real world entity cell, wherein providing the complimentary virtual entity cell comprises instantiating one or more virtual resources using one or more of the stored templates, wherein the one or more virtual resources, when instantiated using the one or more stored templates, are configured to perform management operations for managing the real-world entity cell of the given type.

3. The system of claim 2, wherein to instantiate the one or more virtual resources, the one or more computing devices that implement the hybrid cell management system are further configured to:
allocate computing and/or storage capacity at a cloud-based service provider to be used to instantiate the one or more virtual resources; and
execute program instructions included in the given one or more templates to configure the reserved computing and/or storage capacity of the cloud-based service provider to provide the complimentary virtual entity cell for the given real-world entity cell.

4. The system of claim 2, wherein the one or more computing devices configured to implement the hybrid cell management system are further configured to:
monitor performance of the one or more virtual resources using the allocated computing and/or storage capacity at the cloud-based service provider; and
automatically scale up or scale down the allocated computing and/or storage capacity based on the monitored performance.

5. The system of claim 2, wherein the one or more computing devices configured to implement the hybrid cell management system are further configured to:
configure the one or more virtual resources to provide a user interface to the customers of the requesting tenant, wherein the user interface is provided within an existing user interface of the requesting tenant.

6. The system of claim 5, wherein the one or more computing devices configured to implement the hybrid cell management system are further configured to:
implement at the one or more virtual resources, one or more application programmatic interfaces (APIs) for receiving queries relayed to the one or more virtual resources from the existing user interface of the requesting tenant; and
provide, to the requesting tenant, program instructions for incorporating user interface elements into the existing user interface of the requesting tenant, wherein the user interface elements to be included in the existing user interface of the requesting tenant are configured to generate the queries relayed to the APIs of the one or more virtual resources.

7. The system of claim 5, wherein the one or more computing devices configured to implement the hybrid cell management system are further configured to:
provide, to the requesting tenant, program instructions for incorporating user interface elements into the existing user interface of the requesting tenant, wherein the user interface elements to be included in the existing user interface of the requesting tenant are configured to redirect a customer of the requesting tenant to a user interface implemented via the one or more virtual resources.

8. The system of claim 2, wherein the one or more computing devices configured to implement the hybrid cell management system are further configured to:
receive, from the requesting tenant, information about potential customers of the requesting tenant; and
select a given one or more of the stored templates to be used to instantiate the one or more virtual resources based on the potential customer information.

9. The system of claim 8, wherein the one or more virtual resources instantiated using the given template are further configured to:
identify in one or more public data sources additional information about the potential customers of the requesting tenant; and
generate offers for services to be provided, by the requesting tenant, to the potential customers of the requesting tenant, using the hybrid cell, wherein the offers are generated based on the received information from the requesting tenant about the potential customers and the identified public data about the potential customers, and
wherein the offers are configured to be accepted, to implement a service of a service type of the hybrid cell for the potential customers of the requesting tenant, in response to a single indication of acceptance by a given customer without requiring the given customer to supply additional customer information.

10. The system of claim 2, wherein the real-world entity cells comprise:
cells of a sponsored captive insurance pool, and wherein the different types of real-world entity cells correspond to cells of different sponsored captive insurance pools.

11. The system of claim 10, wherein to perform the management operations, the one or more virtual resources instantiated using the given template are configured to implement:
a pool administration service configured to automatically perform, on behalf of the requesting tenant, administrative tasks for the cell of the sponsored captive insurance pool allocated to the requesting tenant;
a policy administration service configured to automatically perform, on behalf of the requesting tenant, policy administrative tasks for administering insurance policies of customers of the requesting tenant;
a claims administration service configured to automatically perform, on behalf of the requesting tenant, claims administration tasks for claims made by customers of the requesting tenant; and
a metrics service configured to automatically generate and provide metrics to the requesting tenant with regard to the policies and claims administered by the policy administration service and the claims administered by the claims administration service.

12. The system of claim 2, wherein the real-world entity cells comprise:
respective pure captive insurance pools, and wherein the different types of real-world entity cells correspond to different types of pure captive insurance pools.

13. The system of claim 2, wherein the one or more computing devices configured to implement the hybrid cell management system are further configured to:
receive information from the requesting tenant regarding types of risks and/or types of potential customers of the requesting tenant; and
make a recommendation to the requesting tenant of a type of pure captive insurance pool or a type of sponsored captive insurance pool that is to be used for the requesting tenant's real world entity cell.

14. A method, comprising:
receiving, at one or more computing devices implementing a hybrid cell management system, from a requesting tenant, a request to provide a hybrid cell comprising a real-world entity and a virtual entity configured to perform management tasks for the real-world entity, wherein the hybrid cell is configured to provide a service to customers of the requesting tenant;
allocating, by the one or more computing devices implementing the hybrid cell management system, to the requesting tenant, from an inventory of pre-established real-world entities, a given one of a plurality of pre-established real-world entities to function as the real-world entity of the hybrid cell requested by the requesting tenant;
selecting, by the one or more computing devices implementing the hybrid cell management system, from a plurality of types of templates for a plurality of types of real-world entities, a given template for a type of real-world entity allocated to the requesting client;
automatically provisioning, by the one or more computing devices implementing the hybrid cell management system, on behalf of the requesting tenant, computing and/or storage capacity at a cloud-based service provider to be used to instantiate one or more virtual resources that implement the virtual entity;
causing, by the one or more computing devices implementing the hybrid cell management system, the one or more virtual resources to be launched using a machine image or container included in the given template, wherein the machine image configures the one or more virtual resources for performing the management tasks for the type of real-world entity allocated to the requesting client; and
automatically providing, for the requesting tenant, management services for the allocated real-world entity, allocated to the requesting tenant, using the launched one or more virtual resources.

15. The method of 14, further comprising:
receiving, by the one or more computing devices implementing the hybrid cell management system, information from the requesting tenant regarding types of risks and/or types of potential customers of the requesting tenant; and
generating, by the one or more computing devices implementing the hybrid cell management system, a recommendation to the requesting tenant of a type of pure captive insurance pool or a type of sponsored captive insurance pool that is to be used for the requesting tenant's real world entity cell.

16. The method of claim 14, wherein the recommendation further comprises a recommendation of a domicile for the tenant's real world entity cell, wherein the hybrid cell management system maintains pre-established real-world entities in a plurality of domiciles.

17. The method of claim 14, wherein automatically providing the management services for the real-world entity, allocated to the requesting tenant, using the launched one or more virtual resources comprises:
automatically issuing new polices to customers of the requesting tenant, wherein tasks of issuance are performed, at least in part, by the one or more virtual resources; and
automatically administering claims submitted by customers of the requesting tenant, wherein tasks of claim administration are performed, at least in part, by the one or more virtual resources.

18. One or more non-transitory, computer-readable, storage media storing program instructions that, when executed on or across one or more processors, cause the one or more processors to:
receive a request to provide a hybrid cell comprising a real-world entity and a virtual entity configured to perform management tasks for the real-world entity, wherein the hybrid cell is configured to provide a service to customers of a requesting tenant;
allocate, to the requesting tenant, from an inventory of pre-established real-world entities, a given one of a plurality of pre-established real-world entities to function as the real-world entity of the hybrid cell requested by the requesting tenant;
select from a plurality of types of templates for a plurality of types of real-world entities, a given template for a type of real-world entity allocated to the requesting client;
automatically cause computing and/or storage capacity to be provisioned at a cloud-based service provider to be used to instantiate one or more virtual resources that implement the virtual entity; and
cause the one or more virtual resources to be launched using a machine image or container included in the given template, wherein the machine image configures the one or more virtual resources for performing the management tasks for the type of real-world entity allocated to the requesting client.

19. The one or more non-transitory, computer-readable, storage media of claim 18, wherein the real-world entity comprises:
a cell of a sponsored captive insurance pool; or
a pure captive insurance pool.

20. The one or more non-transitory, computer-readable, storage media of claim 19, wherein the program instructions, when executing on or across the one or more processors, further cause the one or more processors to:
receive, from the requesting tenant, information about potential customers of the requesting tenant;
identify in one or more public data sources additional information about the potential customers of the requesting tenant; and
generate offers for services to be provided, by the requesting tenant, to the potential customers of the requesting tenant, using the hybrid cell, wherein the offers are generated based on the received information from the requesting tenant about the potential customers and the identified public data about the potential customers, and
wherein the offers are configured to be accepted, to implement a service of a service type of the hybrid cell for the potential customers of the requesting tenant, in response to a single indication of acceptance by a given customer without requiring the given customer to supply additional customer information.
